(19) United States
(12) Patent Application Publication
(10) Pub. No.: US 2010/0187054 A1
(43) Pub. Date: Jul. 29, 2010

(54) DAMPING ASSEMBLY FOR EXERCISE APPARATUS

(75) Inventor: Chia-Wei Kuo, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: JOONG CHENN INDUSTRY CO., LTD., Nantou-City (TW)

(21) Appl. No.: 12/359,847

(22) Filed: Jan. 26, 2009

(51) Int. Cl. F16F 9/34

(52) U.S. Cl. 188/275

(57) ABSTRACT

A damping assembly includes a guide unit, a damper unit, and a pair of operating members. The guide unit includes a guide bar and a slide sleeve slidably sleeved onto the guide bar. The damper unit is parallel to the guide unit and includes a cylinder and a piston rod, the cylinder being connected with the slide sleeve, the piston rod passing through the cylinder. The cylinder can be driven by the slide sleeve to move straight relative to the piston rod to prevent wear and tear therebetween and to provide equable damping force for the operating members symmetrically mounted to the damper unit to further enable simultaneous actions of the operating members.

### BACKGROUND OF THE INVENTION

1. Field of the Invention

The present invention relates generally to exercise apparatuses, and more particularly, to a damping assembly for an exercise apparatus.

2. Description of the Related Art

Referring to FIG. 1, before operating a conventional chest press machine, a user adjusts the damper 11 properly, sits on the seat 12, and then holds the grips 13 by two hands, the grips 13 being located beside the user's body and at an initial position. While operating the chest press machine, the user puts his or her front arms on the cushions 14 and then pushes his or her shoulder inward; meanwhile, the grips 13 are pivoted via the rotation of the pulleys 15a and 15b located under the seat 12 and the pulley 15a is rotated to synchronically drive the piston rod 16 of the damper 11 to provide a damping force. Next, the user can repeat chest press to exercise the muscles of the chest and the shoulder.

Referring to FIG. 2, before operating a conventional hip abductor 20, the user likewise adjusts the damper 21 properly, sits on the seat 22, holds the grips 23, and then adducts his or her legs to let the legs lie against the cushion 24. While operating the hip abductor 20, the user pushes the cushion 24 outward by his/her legs to enable the link 25 connected with the cushion 24 via the pulleys 26a and 26b located under the seat 22 to drive the cushion 24 to pivot outward and then repeats the outward push and the inward pull to exercise the muscles of the legs.

As far as the above two exercise apparatuses are concerned, each of the dampers 11 and 21 is located close to the left (right) side of the seat 12(22) and connected with one of the pulleys 15a(26a) in such a way that the damping force provided by the damper 11(21) is directly transmitted to the pulley 15a(26a) and then the pulley 15b(26b). In this way, when the user applies a force to the cushion 14(24) to drive the grips 13 (the link 25) to pivot, the damping force received by the grips 13 (the link 25) at the left and right sides is subject to inequality due to the delay of transmittance. In other words, the damping force received by the pulley 15a(26a) connected with the damper 11(21) is more than that of the pulley 15b(26b) without connection with the damper 11(21). For this reason, the grips 13 (the link 25) fail to be operated synchronously because of the inequable damping force to bring negative effect to the user's body building. In addition, the damper 11(21) is located close to the left (right) side of the seat 12(22), such that while the piston rod 16(27) of the damper 11(21) reciprocates with respect to the cylinder 17(28) to provide the damping force, the piston rod 16(27) is subject to wear and tear by the cylinder 17(28) because of the lateral force applied thereto, thus resulting in less smooth action of the piston rod 16(27).

### SUMMARY OF THE INVENTION

The primary objective of the present invention is to provide a damping assembly, which provides an equable damping force for synchronous operation.

The secondary objective of the present invention is to provide a damping assembly, which prevents its damper unit from wear and tear.

The foregoing objectives of the present invention are attained by the damping assembly composed of a guide unit, a damper unit, and a pair of operating members. The guide unit includes a guide bar and a slide sleeve slidably sleeved onto the guide bar. The damper unit is parallel to the guide unit and includes a cylinder and a piston rod, the cylinder being connected with the slide sleeve, the piston rod passing through the cylinder. The operating members are symmetrically located at two sides of the damper unit, each having one end pivotably attached to the slide sleeve.

### BRIEF DESCRIPTION OF THE DRAWINGS

FIG. 1 is a perspective view of a conventional chest press machine.

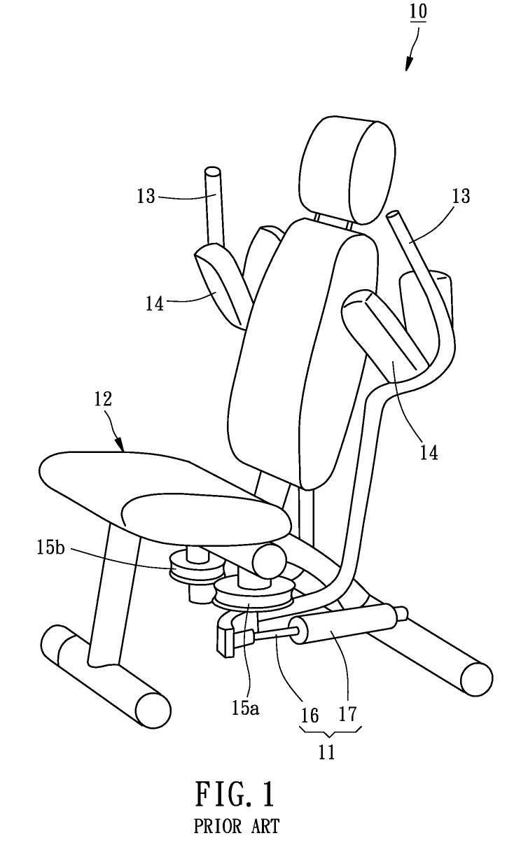

FIG. 2 is a perspective view of a conventional hip abductor.

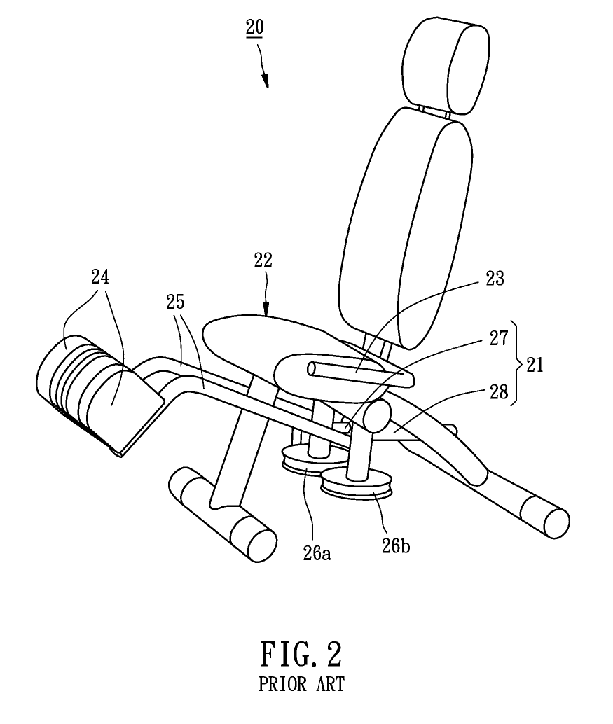

FIG. 3 is a perspective view of a first preferred embodiment of the present invention.

FIG. 4 is a perspective view of the first preferred embodiment of the present invention applied to a chest press machine.

FIG. 5 is a side view of FIG. 4.

FIG. 6 is a top view of the first preferred embodiment of the present invention, illustrating that grips are located at an initial position.

FIG. 7 is similar to FIG. 6, illustrating the grips are located at a midway position.

FIG. 8 is similar to FIG. 6, illustrating the grip is located at a final position.

FIG. 9 is a perspective view of a second preferred embodiment of the present invention applied to a hip abductor.

FIG. 10 is a side view of FIG. 9.

### DETAILED DESCRIPTION OF PREFERRED EMBODIMENTS

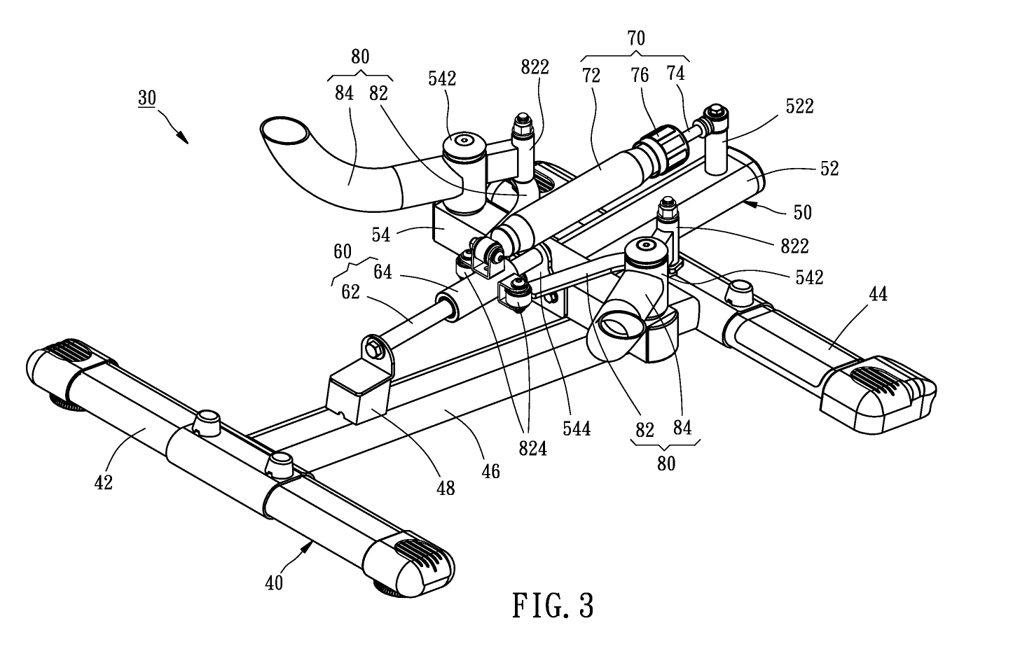

Referring to FIG. 3, a damping assembly 30 for an exercise apparatus in accordance with a first preferred embodiment of the present invention is composed of a chassis 40, a strut frame 50, a guide unit 60, a damper unit 70, and a pair of operating members 80. These components are structurally illustrated in details as well as their interrelationships in the following respective paragraphs.

The chassis 40 includes a first bottom strut 42, a second bottom strut 44 parallel to the first bottom strut 42, and a support strut 46 having two ends each vertically connected with a midsection of one of the first and second bottom struts 42 and 44. The support strut 46 has a quadrangular first fixture 48 protruding upward therefrom close to the first bottom strut 42.

The strut frame 50 includes a first frame body 52 and a second frame body 54 vertically connected with the first frame body 52. The first frame body 52 has a column-shaped second fixture 522 formed at a distal end thereof. The second frame body 54 has two first pivot pieces 542, each of which is formed at one of two distal ends thereof, and a third fixture 544 formed at a front side thereof.

The guide unit 60 includes a guide bar 62 and a slide sleeve 64. The guide bar 62 has a circular cross-section in this embodiment. The cross-section of the guide bar 62 can alternatively be arc-shaped or quadrangular. The guide bar 62 has two ends, one of which is connected with the first fixture 48 and the other is connected with the third fixture 544. The slide sleeve 64 is sleeved onto the guide bar 62 and is slidable forward and backward along the guide bar 62 axially.

The damper unit 70 is parallel to the guide bar 62 and includes a cylinder 72 and a piston rod 74, for providing a damping force. The cylinder 72 has a front end and a rear end, the former of which is connected with slide sleeve 64 and the latter is provided with a tune knob 76 for adjustment of the damping force. The piston rod 74 has a front end and a rear end, the former of which is inserted into the cylinder 72 for reciprocating motion relative to the cylinder 72 and the latter is connected with the second fixture 522. The cylinder 72 can be driven by the slide sleeve 64 to move relative to the piston rod 74 in such a way that the cylinder 72 and the piston rod 74 are simultaneously confined by the slide sleeve 64 and the second fixture 522 to move straight relative to each other.

The operating members 80 are symmetrically located at two opposite sides of the damper unit 70. Each of the operating members 80 includes an arc-shaped first rod 82 and an arc-shaped second rod 84. A front end of the first rod 82 is pivotably attached to the slide sleeve 64. An imaginary straight line connected between the front ends of the two operating members 80 is perpendicular to an imaginary longitudinal axis of the guide bar 62. The first rod 82 has a rear end and a front end, the former of which is provided with a second pivot piece 822 and the latter is provided with a third pivot piece 824. An imaginary straight line connected between central axes of the two third pivot pieces 824 is right vertically bisected by a motion track of the slide sleeve 64 moved relative to the guide bar 62. The second rod 84 has a rear part pivotably attached to the first pivot piece 542. A distal end of the rear part of the second rod 84 is pivotably attached to the second pivot piece 822.

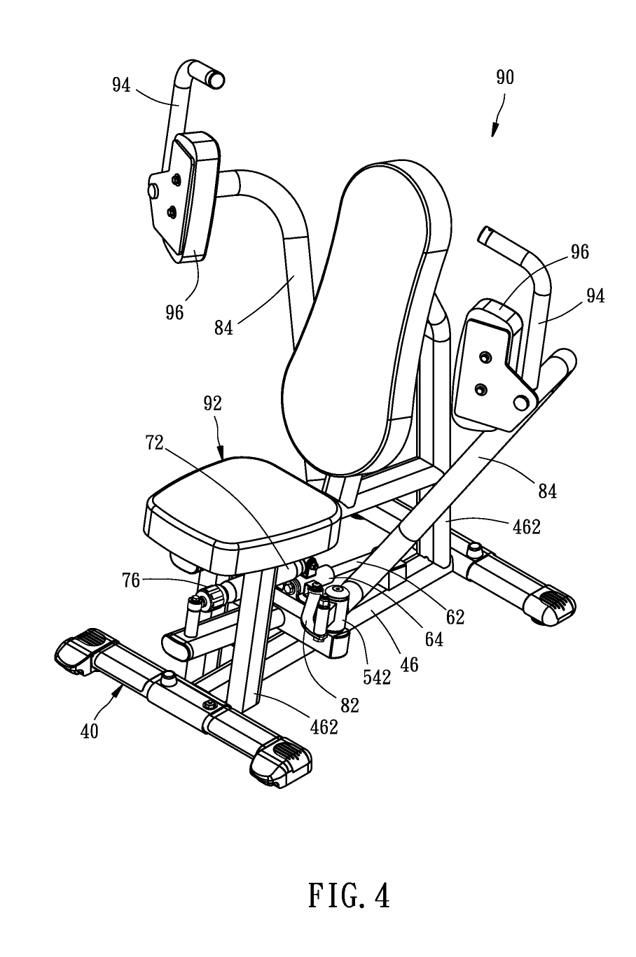

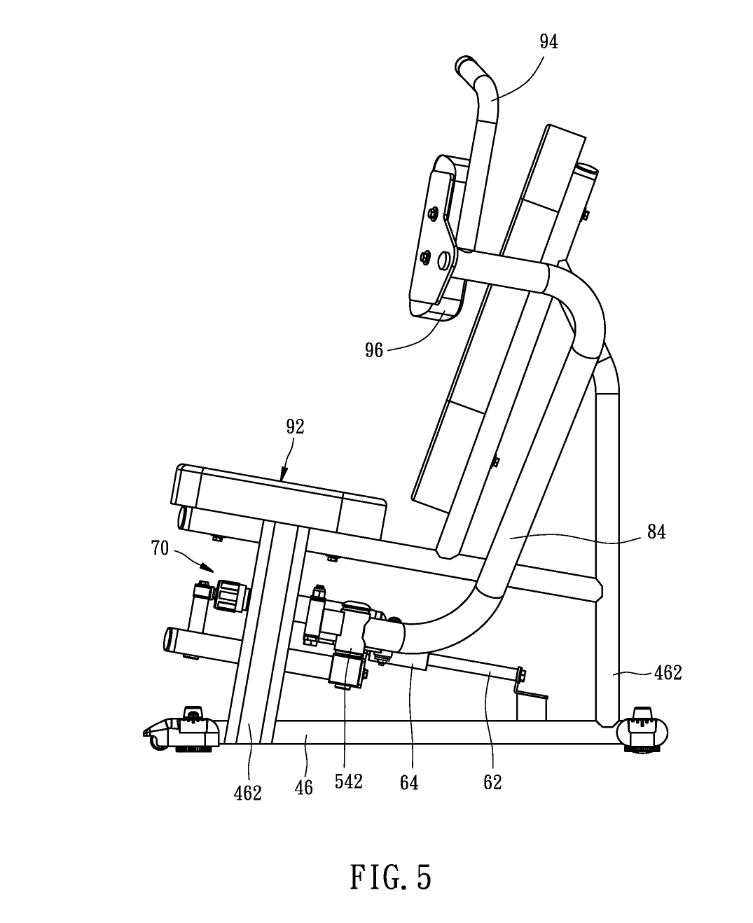

Referring to FIGS. 4 and 5, the damping assembly 30 is applied to the chest press machine 90. The support strut 46 is connected with the seat 92 via two standing struts 462 in such a way that the damping assembly 30 is located under the seat 92 and the second rods 84 of the operating members 80 are connected with grips 94 provided for the user to hold.

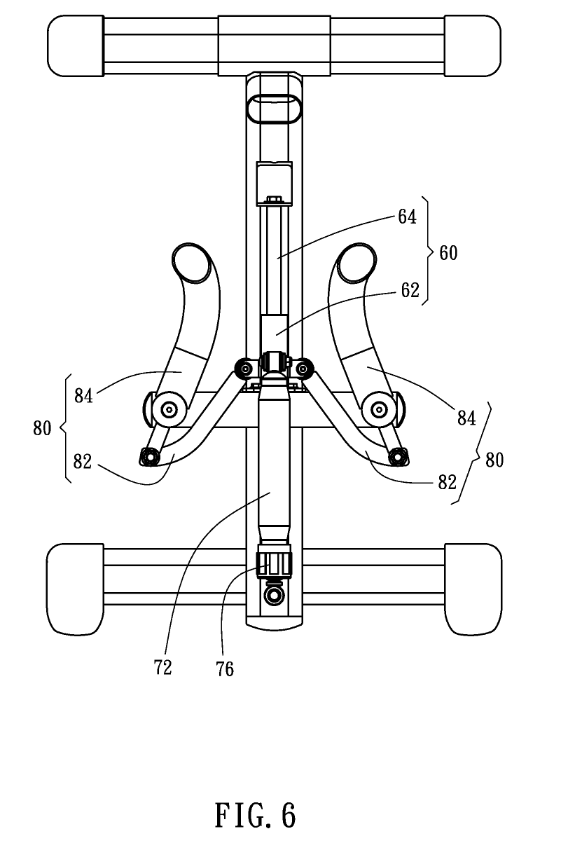

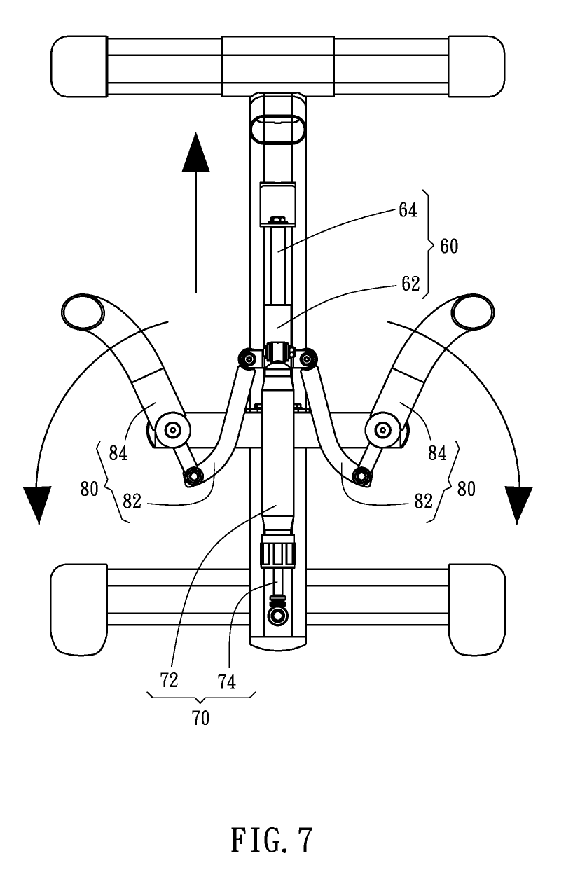

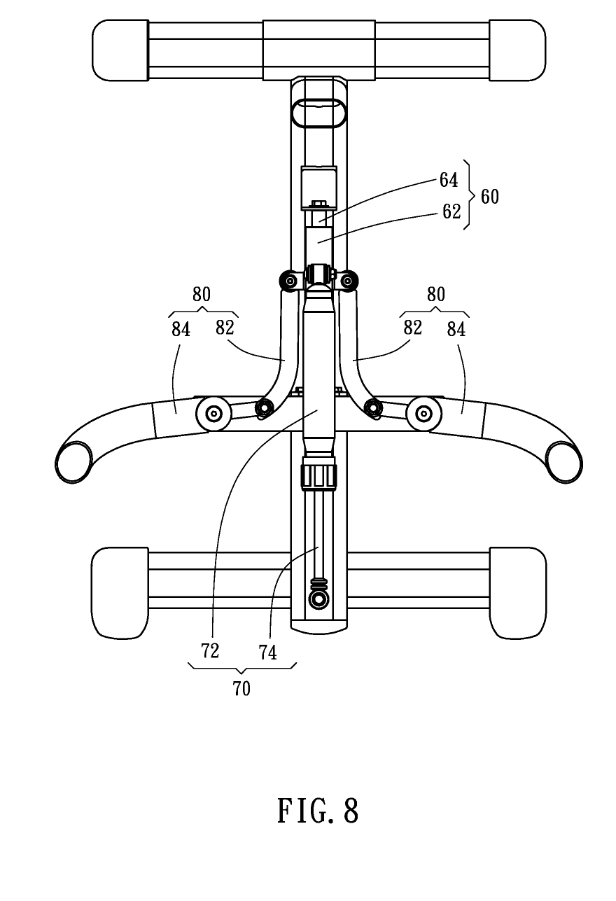

Before operating the chest press machine 90, the user can turn the tune knob 76 to adjust the damping force of the damper unit 70 properly and then hold the grips 94 by two hands, the grips 94 being located at two sides of the user's body, as shown in FIG. 6. Next, the user can let his or her front arms lie against cushions 96 of the chest press machine 90 respectively and then push the cushions 96 to do the chest press; meanwhile, the grips 94 drives the second rods 84 on the first pivot pieces 542 to pivot forward and then to push and force the slide sleeve 64 via the first rods 82 to slidably reciprocate along the guide bar 62. When the slide sleeve 64 slides, the slide sleeve 64 simultaneously pulls the cylinder 72 to enable relative movement of the cylinder 72 and the piston rod 74 for providing the damping force, as shown in FIGS. 7 and 8. After the user completes the chest press and remains the action for seconds, the user can release the force applied to the cushions 96 to allow the statuses of the operating members 80, the cylinder 72, and the slide sleeve 64 in FIG. 8 to revert to those in FIG. 6. Next, the user can push the cushions 96 again to repeat the chest press and stretch to exercise the muscles of the user's chest and shoulders.

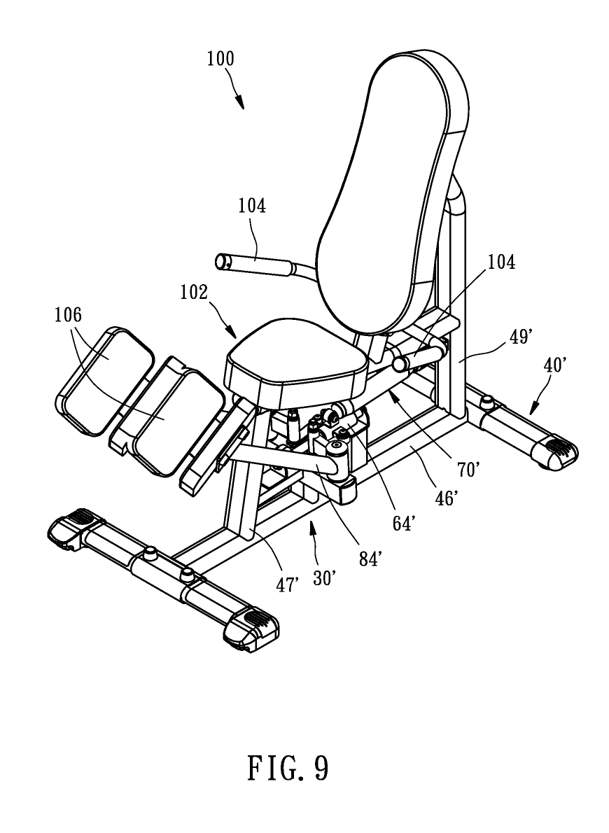

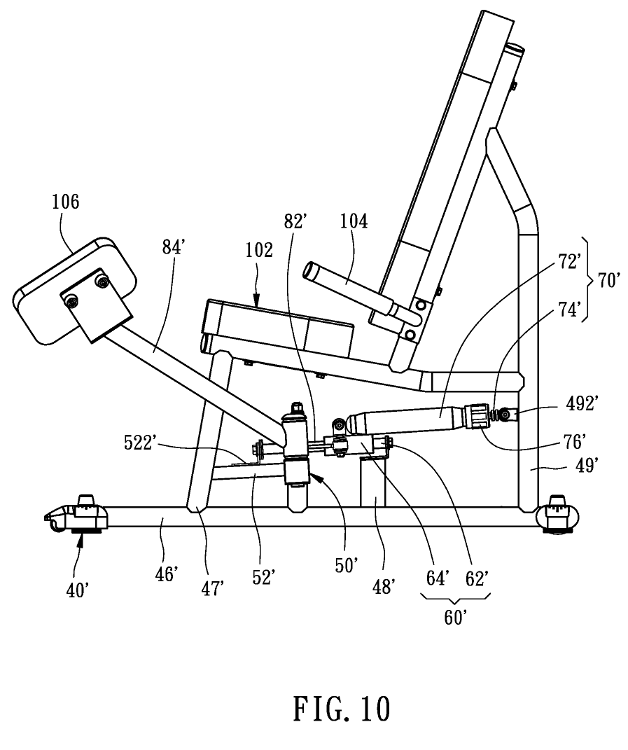

Referring to FIGS. 9 and 10, a damping assembly 30′ in accordance with a second preferred embodiment of the present invention is applied to a hip abductor 100. The damping assembly 30′ of the second embodiment is similar to and different from that of the first embodiment as recited below.

In this embodiment, the chassis 40′ further includes a first standing strut 47′ and a second standing strut 49′, both of which are vertically connected with the support strut 46′. The second standing strut 49′ has a second fixture 492′. The first frame body 52′ is connected with the first standing strut 47′ and has a third pivot piece 522′. The guide bar 62′ has two ends, one which is connected with the first pivot piece 48′ of the support strut 46′ of the chassis 40′ and the other is connected with the third pivot piece 522′ of the first frame body 52′ of the strut frame 50′. The piston rod 74′ of the damper unit 70′ is connected with the second fixture 492′ of the second standing strut 49′ of the chassis 40′.

Before operating the hip abductor 100, the user can turn the tune knob 76′ to adjust the damping force of the damper unit 70′ properly, sit on the seat 102, hold the grips 104 by two hands, and adduct his or her legs lying closely against the cushions 106. During the operation, the user's legs push the cushions 106 sideward to enable the second rods 84′ to pivot and to drive the slide sleeve 64 via the first rod 82′ to slide forward along the guide bar 62′. While the slide sleeve 64′ slides, it likewise pulls the cylinder 72′ to enable the relative movement of the cylinder 72′ and the piston rod 74′ for providing the damping force. Next, the user can repeat the legs stretch and adduction to exercise the muscles of the user's legs.

In conclusion, the damper unit of the present invention is mounted between the operating members and the guide unit allows each of the operating members to receive the equable damping force for simultaneous operation. The slide sleeve keeps the cylinder and the piston rod in straight movement relative to each other to effectively prevent the cylinder and the piston rod from wear and tear due to the lateral force.

Although the present invention has been described with respect to specific preferred embodiments thereof, it is no way limited to the details of the illustrated structures but changes and modifications may be made within the scope of the appended claims.

What is claimed is:

1. A damping assembly for an exercise apparatus, comprising:
a guide unit having a guide bar and a slide sleeve slidably sleeved onto said guide bar;
a damper unit parallel to said guide bar, said damper unit having a cylinder and a piston rod, said cylinder being connected with said slide sleeve, said piston rod being inserted into said cylinder; and
a pair of operating members symmetrically located at two sides of said damper unit and having an end pivotably attached to said slide sleeve.

2. The damping assembly as defined in claim 1 further comprising a chassis and a strut frame, wherein said chassis includes a first pivot piece and said strut frame includes a second pivot piece and a third pivot piece; said guide bar has two ends, one of which is connected with said first pivot piece of said chassis and the other is connected with said third pivot piece of said strut frame; said piston rod of said damper unit is connected with said second pivot piece of said strut frame.

3. The damping assembly as defined in claim 2, wherein said chassis comprises a first bottom strut, a second bottom strut, and a support strut vertically connected with said first and second bottom struts; said first pivot piece is located on said support strut; said strut frame comprises a first frame body and a second frame body vertically connected with said first frame body, said first frame body being parallel to said damper unit; said second pivot piece is located on said first frame body; said third pivot piece is located on said third pivot piece.

4. The damping assembly as defined in claim 3, wherein each of said operating members comprises a first rod and a second rod, said first rod having two ends, one of which is pivotably attached to said slide sleeve and said second rod, said second rod being pivotably attached to said second frame body of said strut frame.

5. The damping assembly as defined in claim 1 further comprising a chassis and a strut frame, wherein said chassis includes a first pivot piece and a second pivot piece, and said strut frame includes a third pivot piece; said guide bar has two ends, one of which is connected with said first pivot piece of said chassis and the other is connected with said third pivot piece of said strut frame; said piston rod of said damper unit is connected with said second pivot piece of said chassis.

6. The damping assembly as defined in claim 5, wherein said chassis comprises a first bottom strut, a second bottom strut, a support strut vertically connected with said first and second bottom struts, a first standing strut connected with said support strut, and a second standing strut connected with said support strut; said first pivot piece is located on said support strut; said second pivot piece is located on said second standing strut; said strut frame comprises a first frame body parallel to said damper unit; said third pivot piece is located on said first frame body.

7. The damping assembly as defined in claim 6, wherein said strut frame further comprises a second frame body, said second frame body being vertically connected with said first frame body and connected with said first standing strut of said chassis; each of said operating members comprises a first rod and a second rod, said first rod having two ends, one which is pivotably attached to said slide sleeve and the other is pivotably attached to second rod, said second rod being pivotably attached to said second frame body.

8. The damping assembly as defined in claim 1, wherein each of said operating members comprises a pivot piece pivotably attached to said slide sleeve, and a motion track of said slide sleeve moved relative to said guide bar bisects an imaginary straight line connected between said two pivot pieces of said operating members.
